(19) United States
(12) Patent Application Publication
(10) Pub. No.: US 2019/0351516 A1
(43) Pub. Date: Nov. 21, 2019

(54) MICRO ASSEMBLY USING MICRO MULTI-TOOLS

(71) Applicant: DWFritz Automation, Inc., Wilsonville, OR (US)

(72) Inventors: Brian P. Phillips, Tualatin, OR (US); Richard J. Browne, Portland, OR (US); Chris E. Barns, Tigard, OR (US); Shawn A. Boling, Tigard, OR (US); Derek Graham Aqui, Portland, OR (US)

(21) Appl. No.: 16/416,013

(22) Filed: May 17, 2019

Related U.S. Application Data
(60) Provisional application No. 62/673,102, filed on May 17, 2018.

(51) Int. Cl. B23P 21/00; B23Q 3/06; B25J 13/08

(52) U.S. Cl. CPC B23P 21/004; B25J 13/085; B23Q 3/062

(57) ABSTRACT

Disclosed is a multi-tool assembly system and associated methods for threading small spheres or other objects with through-holes onto small diameter wire or fiber, trimming excess wire, and securing them in position with adhesive. The tools can precisely manipulate objects having diameters of less than 25 microns in a reliable, repeatable manner and may operate semi-autonomously, fully autonomously, or in a manual mode.

### RELATED APPLICATION

The application claims priority benefit of U.S. Provisional Patent Application No. 62/673,102, filed May 17, 2018, which is hereby incorporated by reference.

### TECHNICAL FIELD

This disclosure relates generally to precision engineering micro assembly methods and devices and, more particularly to, manipulation of small beads and wires.

### BACKGROUND INFORMATION

U.S. Pat. No. 8,333,796 of Tompkins et al. describes attempts to mechanically release an embolic coil from a microcatheter. For example, a ball affixed to a proximal end of the embolic coil is retained within an insertion tip of the microcatheter and held against an inner sidewall of the tip in a gap between two so-called engaging elements. When the coil is deployed, the engaging elements are moved outward from the insertion tip of the microcatheter, thereby moving the ball from being held against the sidewall and releasing it and the proximal end of the coil to which the ball is attached. The ball applies tension to the coil because it is tethered to an atraumatic (i.e., rounded) distal tip of the coil by a slender filament (wire, thread, fiber, or the like) passing through the center of the coil. In other words, the coil has a ball tethered by a filament attached to the opposing tip at the opposite end of the coil. Likewise, the aforementioned engaging elements are tethered so that they may be ejected from and retracted into the tip of the microcatheter by pulling or releasing a strand tethering the engaging elements.

As summarized above, in the specific attempt described in the '796 patent, there are at least four non-ferrous (i.e., non-magnetic) beads, spheres, balls, or the like that are assembled to filaments. But because such filaments and spheres are so small (e.g., on the order of hundreds of micrometers or less in diameter), assembling these components by hand in a repeatable manner and at high yields has been challenging for medical device manufacturers and potentially other precision engineering fields. The current assembly process is manually intensive and requires exceptional dexterity and beyond-excellent vision.

### SUMMARY OF THE DISCLOSURE

Disclosed are a multi-tool assembly system and associated methods for threading small spheres or other objects having through-holes onto small diameter wire, fiber, rod, or pin, trimming excess filaments, and securing components in position with adhesive. The tools can precisely manipulate objects having a diameter of about 200 μm or less in a reliable, repeatable manner and may operate semi-autonomously, fully autonomously, or in a manual mode.

This disclosure describes enhancements to the following eight precision engineering tasks: (1) presenting two thin (e.g., in a range between about 25-250 μm) filaments preparatory to transferring a small rounded object from one filament to the other; (2) removing a small rounded object that is threaded on a thin filament that may carry additional rounded objects; (3) transferring the small rounded object onto another filament; (4) manipulating the small rounded object over a looped section of fiber; (5) bonding end portions of two filaments; (6) seating a retaining device into an aperture of the through-hole of the small rounded object; (7) cutting an unseated portion of the retaining device; and (8) applying adhesive to the seated retaining device.

The tools and methods described herein apply to multiple business segments including, but not limited to: medical (e.g. implant); aerospace; micro, nano, and pico manufacturing/technology; electrical discharge machining (EDM) inspection and handling; and micro machines and machining.

In addition to providing relief to operators performing a complicated manual task, the tools and methods described also provide several key benefits, including: (1) modularity that enables varied configurations which can accommodate new part designs, implementation of upgraded components, and scalability; (2) a suitable platform for integrating an inspection and metrology system, including the automatic characterization of defects; and (3) the ability to adjust processes “on-the-fly,” facilitating the development of new methods of assembly or identification of those needing improvement. Among other things, the disclosed systems and methods provide: product uniformity due to consistent part handling and repeatability of operations; improved assembly quality due to benign handling of fragile parts and precisely controlled movements; reduced operator fatigue due to automated and assisted manual modes; vision system, manual or automated; and decreased assembly time.

Additional aspects and advantages will be apparent from the following detailed description of embodiments, which proceeds with reference to the accompanying drawings.

### BRIEF DESCRIPTION OF THE DRAWINGS

FIG. 1 is an enlarged isometric view of ten platinum spheres (i.e., beads) having tapered though-holes and strung on a stainless steel wire, with larger openings of the tapered though-holes facing toward a bend in the wire for presentation of smaller openings to assembly stations including micro tools used to, among other things, transport a sphere from an unbent end of the wire.

FIG. 2 is an enlarged fragmentary isometric view of a coil through which a fiber loop extends and showing a stainless steel wire, different from the stainless steel wire of FIG. 1, looped through the fiber loop.

FIG. 3A is an isometric view showing mutually angularly spaced-apart spherical magnets in a base of a transportable kinematic mount portion for precisely attaching it to an anchored kinematic mount portion so as to form a kinematic mount site for presentation to an assembly station the coil and wire of FIG. 2, the latter of which being held in place by stacked spherical magnets.

FIG. 3B is an enlarged fragmentary isometric view of FIG. 3A showing in greater detail the stacked spherical magnets retaining the looped stainless steel wire in a v-groove of the transportable kinematic mount portion.

FIG. 4 is another enlarged fragmentary isometric view similar to that of FIG. 3B, but showing in the v-groove the stainless steel wire of FIG. 1.

FIG. 5 is a sectional view of a transportable kinematic mount portion similar to those of FIGS. 3A, 3B, and 4, but holding the coil and wire of FIG. 2 using three vacuum ducts instead of stacked magnets for securing the wires in v-groove at the surface of the transportable kinematic mount portion.

FIG. 6 is an enlarged fragmentary isometric view of a sphere of FIG. 1 held by a vacuum tip manipulation tool when transporting the sphere from the unbent end of the wire shown in FIG. 1, according to a first embodiment.

FIG. 7 is an enlarged isometric view of a piezo-actuated flexure tool shown prior to gripping a sphere of FIG. 1 preparatory to transporting the sphere from the unbent end of the wire shown in FIG. 1, according to a second embodiment.

FIG. 8 is an enlarged isometric view of a fixture tool including confronting conical tubes that funnel free ends of the looped stainless steel wire of FIG. 2 toward a tethered sphere on the unbent stainless steel wire of FIG. 1 preparatory to transporting the sphere from the unbent end to the looped stainless steel wire, according to a third embodiment.

FIG. 9 is a perspective view of an experimental assembly station including two facing kinematic mount sites and components shown in FIGS. 3B and 4, a pair of micrometer-controlled three-axis stages for transferring a platinum sphere using micrometer position adjustment of one or more of the tools of FIGS. 6-8 and micrometer-actuated tweezers holding free ends of the looped stainless steel wire that are simultaneously threaded through the smaller opening of the tapered though-hole, a monitor showing a greatly magnified view of the coil after the platinum sphere has been loaded and then pulled over the fiber loop, and associated optics and lighting devices.

FIG. 10 is an enlarged fragmentary isometric view showing in greater detail tongs and axially gripping tweezers available at the assembly station of FIG. 9 and configured for performing the aforementioned load and pull operations when transferring the platinum sphere onto the fiber loop via the looped stainless steel wire.

FIG. 11 is an enlarged side elevation fragmentary view of a free end of the looped stainless steel wire (OD 0.001 inch) bonded to that of a platinum wire (OD 0.002 inch) using cyanoacrylate adhesive, solder, or electric resistance welding preparatory to pulling by the non-bonded free end of the looped stainless steel wire so that the platinum wire is neatly threaded into the fiber loop, thereby swapping locations with the looped stainless steel wire while reducing snags of, and misalignments through, filaments forming the fiber loop.

FIG. 12 is an enlarged fragmentary isometric view of a collet fixture rotatable within its transportable kinematic mount portion about a longitudinal axis of a workpiece (e.g., the coil of FIG. 2 including bonded wires of FIG. 11), the collet fixture including a groove and spring clip to, respectively, align and secure the workpiece while pulling by the non-bonded free end of the looped stainless steel wire to position the platinum wire in the fiber loop.

FIGS. 13A and 13B are, respectively, enlarged isometric and fragmentary detail views showing an assembly station including a clamp fixture to hold a platinum sphere in place when trimming the platinum wire of FIGS. 11 and 12 as a blade is guided by a slit in the clamp fixture.

FIG. 14 is an isometric view of another assembly station including a seating tool for seating the sphere against the trimmed platinum wire and showing an adhesive dispenser needle in position to place adhesive onto trimmed ends so as to retain the sphere on the looped end portion of the fiber loop.

FIG. 15 is a hybrid process flow and system pictorial diagram showing the sequence of operations performed by assembly stations of the disclosed automated system for micro assembly of a workpiece.

FIG. 16 is an isometric view of a cabinet housing the automated system shown in FIG. 15.

FIG. 17 is an enlarged fragmentary isometric view of a proximal end of a partly assembled embolic coil in a protective slit sheath tubing.

FIG. 18A is an isometric view of an extendable collet holding the components of FIG. 17.

FIG. 18B is an enlarged fragmentary isometric view showing in greater detail the collet tip shown in FIG. 18A.

FIG. 19 is an isometric view of an underside of collet fixture acting as a transportable kinematic mount portion for carrying the collet of FIG. 18A to anchored kinematic mount portions.

FIG. 20 is an isometric view of the collet fixture of FIG. 19 atop a collet positioning tool for adjusting forks retaining the collet preparatory to loading the collet fixture on a carousel.

FIG. 21 is an isometric view showing in greater detail a seat and trim assembly station shown in FIG. 15.

FIG. 22 is an isometric view showing in greater detail an adhesive dispense and cure assembly station shown in FIG. 15.

### DETAILED DESCRIPTION OF EMBODIMENTS

Although any of the assembly tasks described in this disclosure may be performed discretely and separately from the other tasks, for ease of description and providing a concise narrative, the tasks are described in accordance with an assembly sequence and in connection with an example assembly project. The assembly project itself and resulting assembled device, however, are not a limitation on the scope of this disclosure, as skilled persons will appreciate that any of the tasks and their variants have widespread applicability to various precision engineering fields including, among others, medical device manufacture. Thus, the technologies may, alone or in combination, be employed to automate or partly automate assembly, increase yields, and improve consistency.

### Example Inputs and Associated Assembly Project

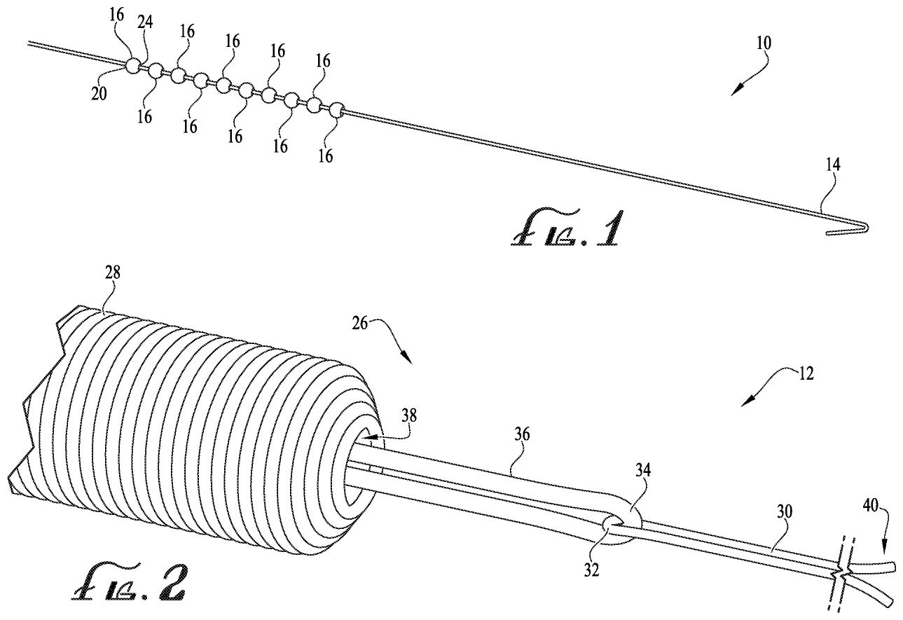

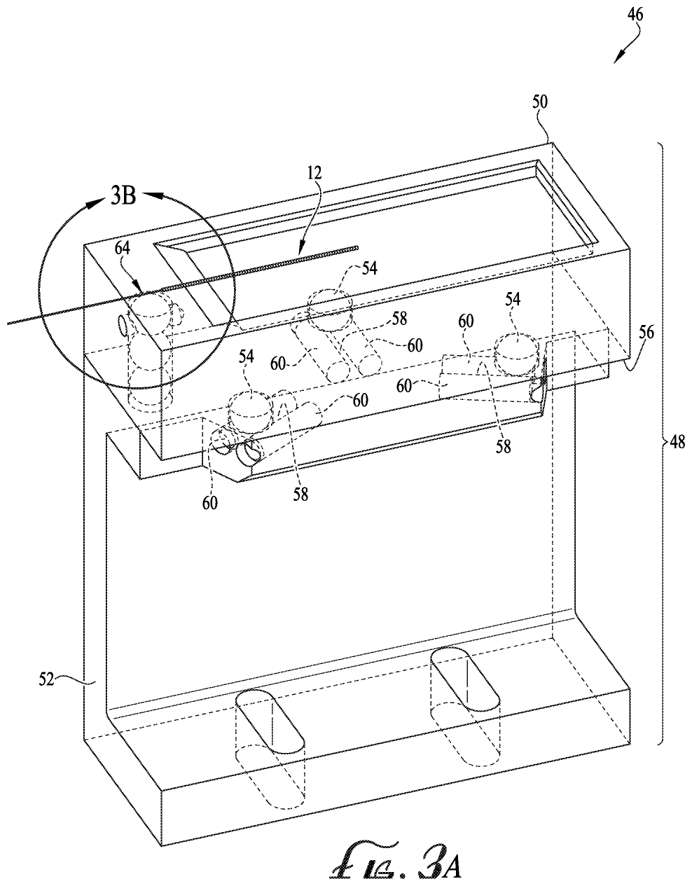

FIGS. 1 and 2 show two inputs to a micro assembly project. As noted previously, the particular project simply serves as an example. Another example described later is based on a different input that is a partly preassembled version of first and second inputs 10, 12. Also, sizes and shapes of the components of the example assembly projects may vary. For instance, other types of three-dimensional objects with holes may be used. And apertures and thicknesses of the workpieces may have a constant or variable cross-sectional shapes and inside or outside diameters, for example. In some other experiments, sizes were initially scaled up by a factor of about 10 times so as to test different manipulation techniques and micro assembly tools. Thus, at least some of the techniques described in this disclosure are applicable for manipulation of small objects in a range of sizes from about 2,000 μm to about 200 μm.

FIG. 1 shows first input 10 in the form of a first stainless steel microstrand wire 14 having a diameter of about 0.001 inch (about 25 μm). A set of ten platinum beads 16 is threaded thereon. Each bead 16 has an outside diameter of about 0.008 inch (about 200 μm). A first (so-called entrance) hole 20, e.g., at the left of each bead 16, has a diameter of about 0.003 inch (about 76 μm). A second (so-called exit) hole 24, e.g., at the right of each bead 16, has a diameter of about 0.006 inch (about 152 μm). Thus, an aperture through each bead 16 is tapered from exit hole 24 to entrance hole 20. Aside from material absent in forming these holes, beads 16 are generally spherical in shape.

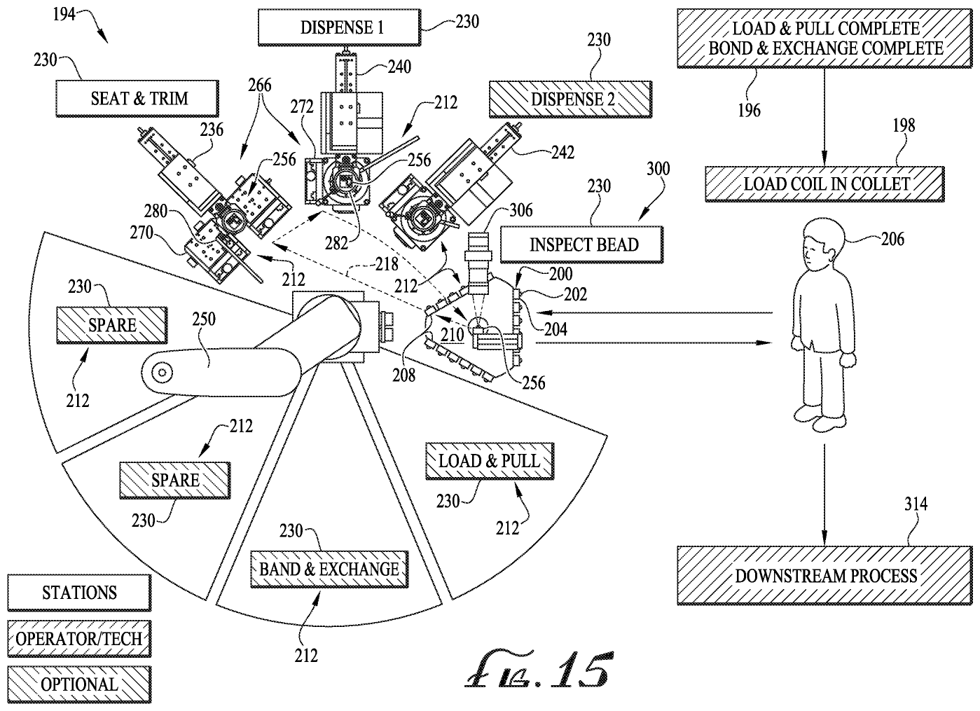

FIG. 2 shows second input 12 in the form of a partly assembled proximal end 26 of an embolic coil 28, according to one example. In the present disclosure, the terms proximal and distal are used with reference to a microcatheter (not shown), in which a distal end (not shown) of embolic coil 28 points away from the microcatheter and a fully assembled proximal end (see e.g., FIG. 14) is the end that is released last from the microcatheter. Accordingly, proximal end 26 is more generally referred to a workpiece that includes a filament having one or both of a micro bead and a wire.

Partly assembled proximal end 26 of embolic coil 28 includes a second stainless steel microstrand wire 30, different from first stainless steel wire 14 (FIG. 1), that has a diameter of about 0.001 inch (about 25 μm). As an optional input to an automated assembly system explained later, wire 30 is pre-looped 32 through an opposing loop 34 of polyethylene (PE) fiber(s) 36. Because wire 30 is about 0.001 inch (about 25 μm), loop 32 formed from doubled-over wire 30 is about 0.002 inch (about 50 μm). In contrast, PE fiber 36 is somewhat compressible such that loops 32 and 34 are collectively sized to enter into entrance hole 20 of bead 16 and pass through its aperture during assembly operations discussed later with respect to FIG. 10.

PE fiber 36 is actually formed from many strands extending through a central aperture 38 of embolic coil 28. For sake of simplicity, the numerous filaments are not shown. Note, however, that the numerous filaments introduce automation challenges having solutions discussed later in terms of replacing wire 30 with a platinum counterpart and avoiding excess wicking of adhesive.

Free ends 40—i.e., proximal ends according to the microcatheter reference frame mentioned previously—of second stainless steel wire 30 are free to dangle away from opposing loop 34 of PE fiber 36. Other ends (not shown) of PE fiber 36 are anchored to another component that is not relevant to the present example.

### Kinematic Mount Sites for Presentation of Workpieces

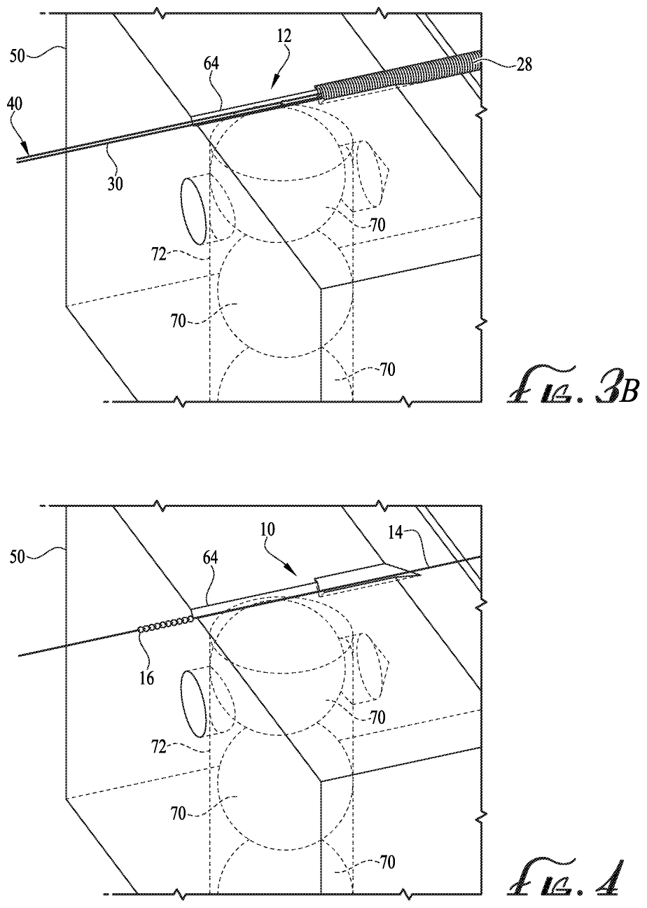

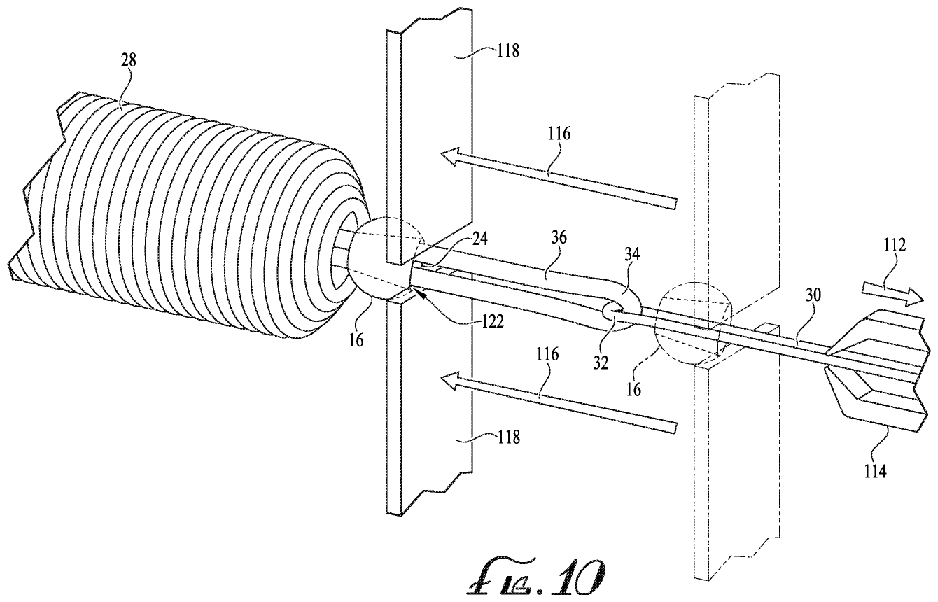

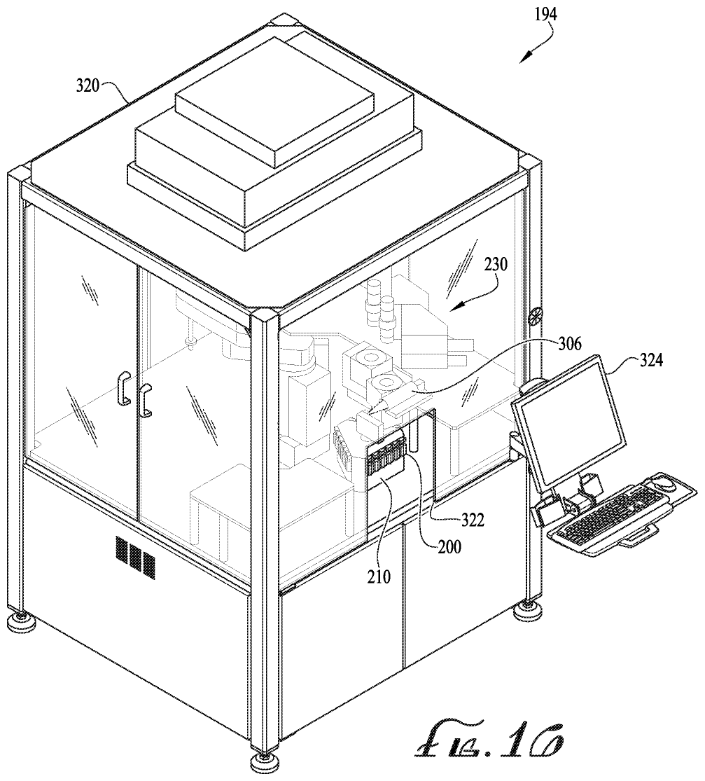

Kinematic mounts are used to securely hold one or more wires, which themselves may be loaded with spheres or other small objects as explained in the next section. Multiple kinematic mounting sites are located at different assembly stations (see e.g., FIGS. 9 and 15). For example, as shown in FIG. 3A, a kinematic mounting site 46 provides a two-piece kinematic mount 48 formed when a transportable kinematic mount portion 50 is attached to a corresponding one of multiple anchored kinematic mount portions fixed at an associated kinematic mounting site. Specifically, two-piece kinematic mount 48 is formed when (top) transportable kinematic mount portion 50 is placed atop an anchored kinematic mount portion 52 (bottom, C-shaped) rigidly affixed to a selected assembly station or a moveable structure such as an assembly carousel (see e.g., FIG. 15).

Two-piece kinematic mount 48 is 3D-printable and relatively inexpensive, yet highly precise in terms of presenting inputs 10, 12 to micro tools arranged according to an assembly sequence carried out at different assembly stations when transportable kinematic mount portion 50 is automatically moved to corresponding anchored kinematic mount portions seriatim at the different assembly stations. Thus, two-piece kinematic mount 48 provides accurate and repeatable positioning of workpieces within range of a variety of specialized micro-manipulation tools and in the field of view and depth of focus of a vision and lighting systems, as shown in FIGS. 9, 15, 21, and 22.

Top portion 50 is retained on anchored kinematic mount portion 52 by three spherical magnets 54 exposed on or embedded in a base 56 (e.g., bottom face) of top portion 50. When top portion 50 is placed on anchored portion 52, each magnet 54 is magnetically fastened in a gap 58 between a corresponding pair of metal dowels 60. Because gaps 58 collectively define longitudinal axes intersecting at an exact center, and magnets 54 are precisely positioned with respect to each other and dowels 60, top portion 50 is fully constrained (not over constrained) in six-degrees of freedom to a location that has a tolerance of about 1 μm. Accordingly, top portion 50 can be removed completely for loading first or second inputs 10, 12 into or removing them out from a v-groove 64 of top portion 50.

Once loaded or unloaded, top portion 50 may be returned to a desired kinematic mounting site with high repeatability in terms of its position. Likewise, because top portion 50 is transportable, it may be separated from anchored portion 52 and placed in another anchored portion at a different orientation (e.g., placed upright) when transporting to another kinematic mounting site 46 first or second inputs 10, 12 retained in v-groove 64 of top portion 50.

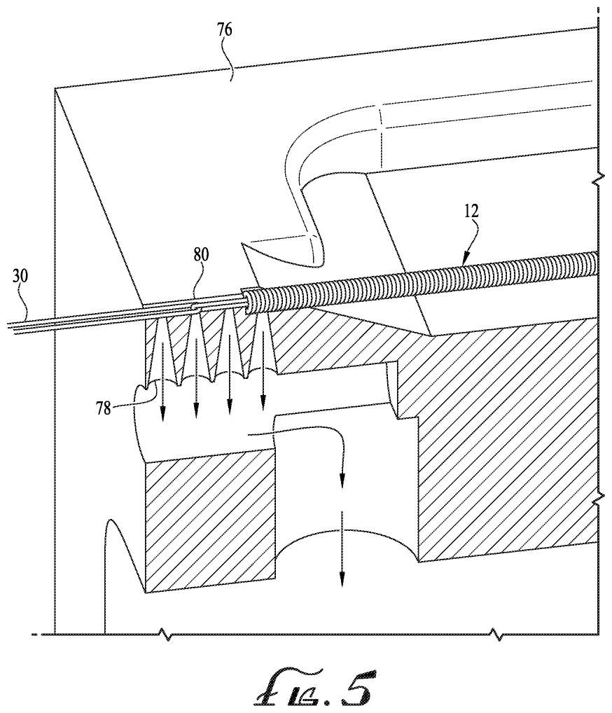

As shown in FIGS. 3B and 4, v-groove 64 acts as a guide in top portion 50 that facilitates constraint of inputs 10, 12. For example, free ends 40 of second stainless steel wire 30 are held so that they are parallel and in close proximity to each other. Also, wire 30 (FIG. 3B) and wire 14 (FIG. 4) are shown being held firmly in place by spherical magnets 70 stacked inside a channel 72 under v-groove 64. Magnets 70 maintain the rigidity of the wire for transferring one of platinum spheres 16 (FIG. 4) from wire 14 to wire 30 (FIG. 3B), which is described later. In other embodiments, each kinematic mount 48 can accommodate several parallel wires at once in multiple v-grooves or other structures.

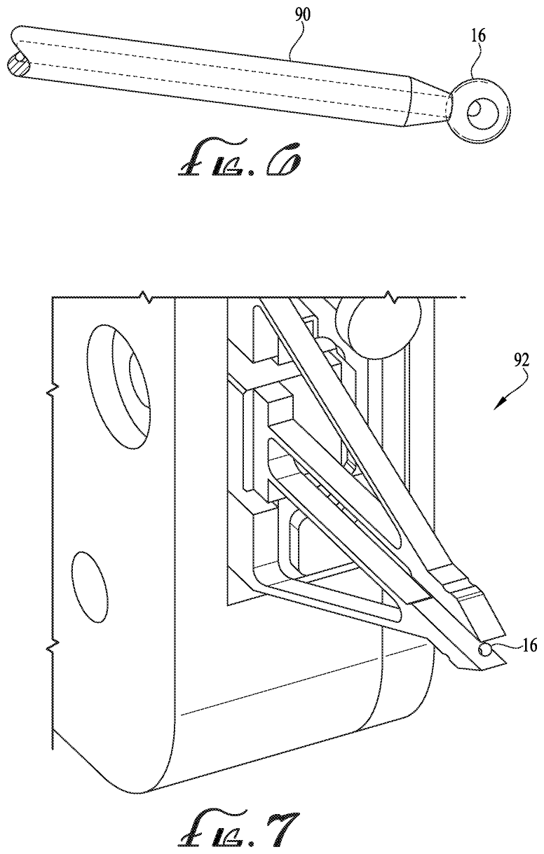

In addition to or as a substitute for magnets below v-groove 64, e.g., in cases where wires are not magnetic, there are a number of different ways to present a wire to the manipulation tools described in the following sections. For example, a metal endcap can be placed on non-magnetic portions so that the endcap provides magnetic attraction. In another embodiment, FIG. 5 shows a transportable kinematic mount portion 76 that secures input 12 by employing vacuum suction through a series of ducts 78 located in suction trough 80. Other mounts may use a combination of adhesives, magnetic force, vacuum suction, tweezers or clamps, surface tension, or gel pack(s).

In some embodiments, v-groove 64 is a depression or trough. Some embodiments include retention devices such as spring clips in addition to or in lieu of grooves.

### Load: Part Manipulation (Removal and Transfer)

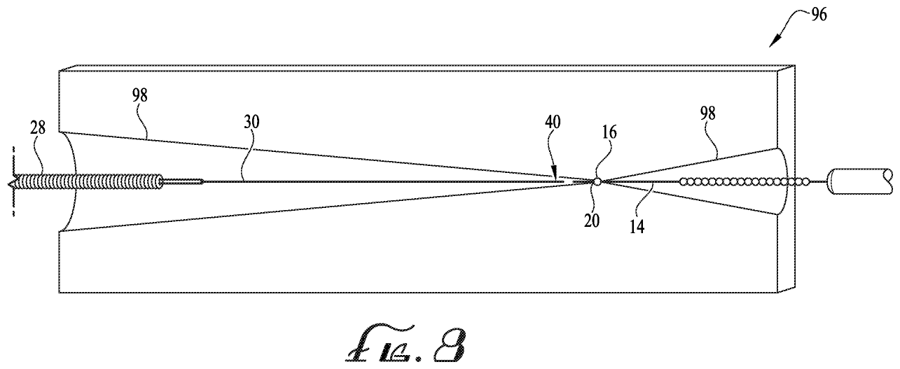

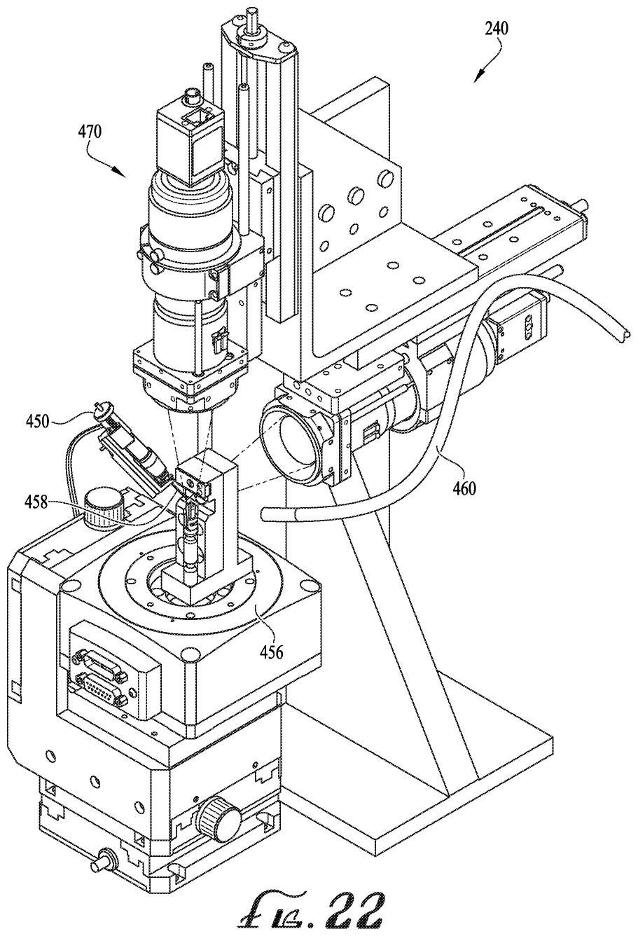

As shown in FIGS. 6-9, manipulation of the spheres and wires is handled by interchangeable micro-tools. The tools are configured differently depending on the object to be manipulated or task to be performed, and can be outfitted with useful implements like vacuum tips 90 (FIG. 6), a piezo-actuated flexure tool 92 (FIG. 7), or pin vises to more intricate clamps designed to hold spheres and provide wire guidance. Actuation of the tools depends on their configurations, but can be accomplished by manual or servo-controlled micrometer adjustment. Movement of a tool within an assembly station can also be accomplished via manual or servo-controlled micrometer adjustment 94 (FIG. 9) or through the use of multi-axis stages 412 (FIG. 21).

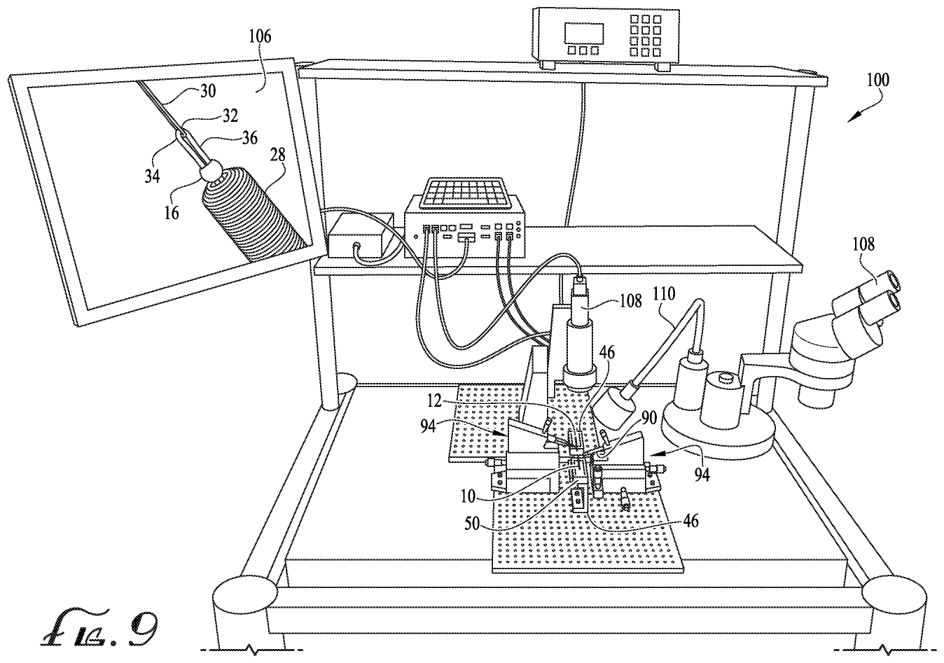

Additionally, manipulation of small spheres or wires can be accomplished with a variety of jigs and methods other than vacuum, some of which may be more effective for other shapes or sizes. For instance, FIG. 8 shows a fixture 96 including confronting conical tubes 98 that funnel free ends 40 of looped wire 30 toward tethered bead 16 on wire 14. Bead 16 is held in place between the funnels so that it can be readily removed from its tether and transferred to free ends 40 once they are advanced into hole 20 of bead 16. This technique was successfully tested on 10× scaled beads and wires.

FIG. 9 is a perspective view of an experimental assembly station 100 including two facing kinematic mount sites 46 and associated components shown in FIGS. 3B and 4, a pair of micrometer-controlled three-axis stages 94, a monitor 106, and associated optics 108 and lighting devices 110.

Using the equipment at assembly station 100, an operator or technician carefully transfers platinum sphere 16 using micrometer position adjustment of one or more of the tools of FIGS. 6-8 and micrometer-actuated tweezers holding free ends 40 of looped stainless steel wire 30. Free ends 40 are moved relative to hole 20 so that they are simultaneously threaded through the tapered though-hole in bead 16. In one experiment, free ends 40 were temporarily held together (for insertion into hole 20) using surface tension provided by lip balm. Coffee and other liquids provide a similar temporary bonding function, which assists in straightening and holding together free ends 40 of looped wire 30.

### Pull: Part Manipulation (Moving Part Over Loop)

Monitor 106 shows a greatly magnified view of coil 28 after platinum sphere 16 has been transferred and then pulled over loop 32 of wire 30 and loop 34 of PE fiber 36. FIG. 10 shows in greater detail how bead 16 is manipulated over loops 32, 34. Axial grip 112 from micro grippers 114 is applied to free ends 40 of wire 30, and opposing force 116 is applied so that tongs 118 near exit hole 24 push a back side 122 of sphere 16 over loops 32, 34. Radial grip is also possible, but due to the small diameter and rounded shapes of free ends 40 of wire 30, it is challenging to properly simultaneously tweeze both filaments.

An optional force sensor (not shown) is integrated into micro grippers 114 such that tensile force can be measured while pulling. The force sensor is configured to indicate an out-of-tolerance condition during pulling of wire 30 and PE fiber 36 through the tapered hole of bead 16.

### Bond and Exchange: Swapping Looped Filaments

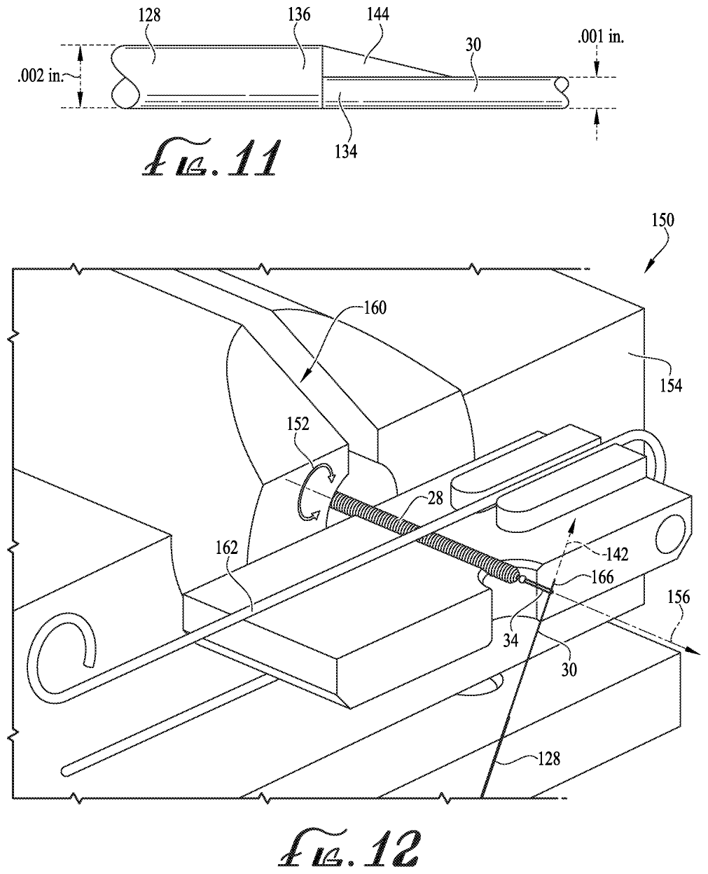

Once sphere 16 is pulled over loops 32, 34, wire 30 is replaced by a platinum wire having a diameter of about 0.002 inch (about 50 μm). In other words, loop 34 of PE fiber 36 will instead be looped around a platinum wire 128 (FIG. 11) that is doubled over to form a loop 130 (FIG. 14) that is about 0.004 inch (about 100 μm). Because loop 130 is wider than loop 32, it lodges within the tapered aperture of exit hole 24 (FIG. 1) when bead 16 is seated against loop 130 and loop 34. This prevents bead from slipping off.

In one embodiment, platinum wire 128 is carefully inserted through loop 34 of PE fiber 36 (akin to threading an eye of a needle), and stainless steel wire 30 is removed. This technique is challenging, however, because PE fiber 36 is made of numerous fraying micro strands, and breaking a strand or failing to capture one of them within loop 130 results in a failed component.

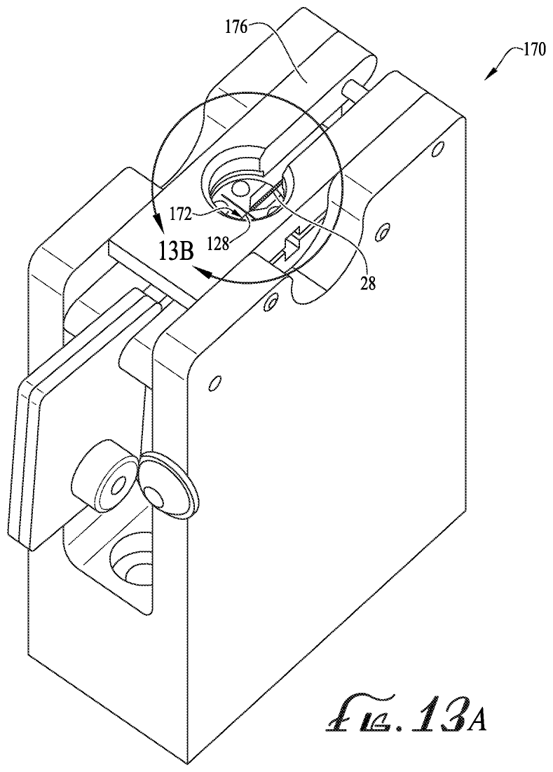

To ensure all strands are captured, the present inventors instead bond one end 134 of stainless steel wire 30 to an end 136 of platinum wire 128. This bond is made while loop 32 is intact so that stainless steel wire 30 may then be pulled 142 (FIG. 12), which pulls platinum wire 128 into loop 34 of PE fiber 36, thereby replacing loop 32 with loop 130. This swap ensures all strands are captured.

The first type of bond shown in FIG. 11 is an end bond. This is achieved, according to some embodiments, by flux and solder coating (i.e., solder pot dipping and tinning) each end, abutting the tinned ends by placing them in v-groove fixtures (magnetic or vacuum v-grooves) so that the ends face each other; and heating the ends so that the solder cures and bonds. An advantage of this technique is that the solder forms a smooth, snag-resistant fillet 144 extending between the 0.002 inch wire and the 0.001 inch wire.

The second type of bond is a lap bond (not shown). A relatively short segment of one filament is bonded to roughly equal portion of the other filament. The bond may be secured by UV-cured adhesive, solder, glues, or other types of bonding agents.

FIG. 12 is an enlarged fragmentary isometric view of a collet fixture 150 that is rotatable 152 within its transportable kinematic mount portion 154 about a longitudinal axis 156 of a workpiece (e.g., coil 28 including bonded wires 128, 30). Collet fixture 150 includes a groove 160 and spring clip 162 to, respectively, align and secure the workpiece while pulling by non-bonded free end 166 of stainless steel wire 30 to position platinum wire 128 in fiber loop 34.

Bonding and exchanging wires is optional in some other embodiments. For example, instead of using stainless steel wire 30, a platinum wire is provided as an input to the system. That platinum wire may include one or more segments that are 0.001 inch and another segment that is 0.002 inch. Accordingly, bead 16 fits over two doubled-over narrower segments (0.002 inch) or doubled-over wider and narrower segments (0.003 inch). Once bead 16 passes over, the wide segments of 0.002 inch are moved into exit hole 24 and doubled over to form a platinum loop that is 0.004 inch for trapping bead 16 (which is also called a proximal constraint since it is used for retaining in and releasing from a micocatheter, coil 28). A platinum wire having different segment widths can be formed by pulling segments of a 0.002 inch wire through a 0.001 inch die.

### Seat: Seating Bead

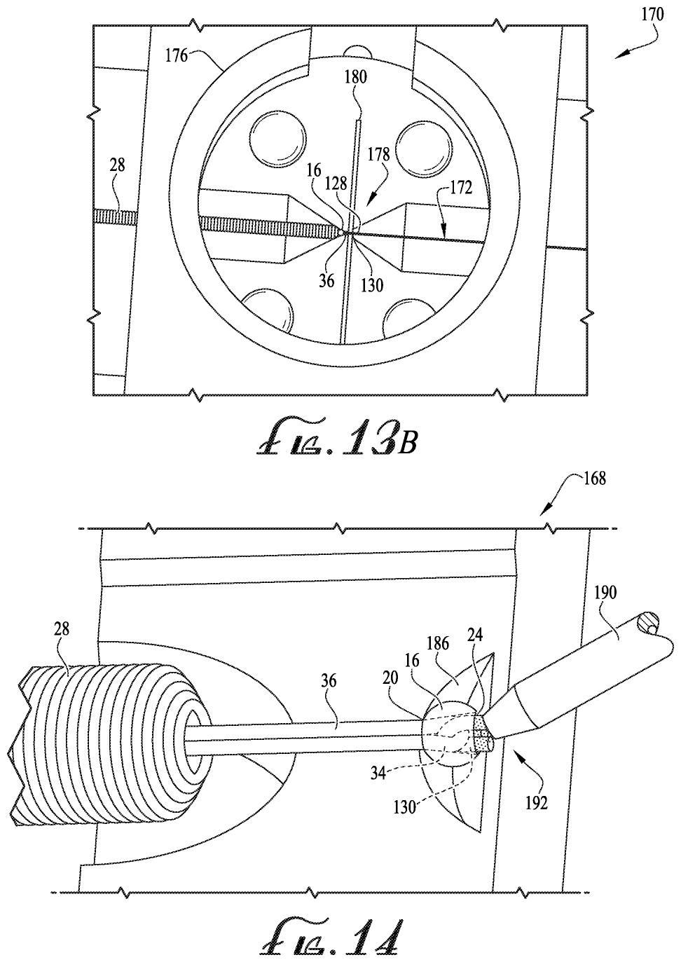

FIGS. 13B and 14 show bead 16 that has been seated against loop 130. To seat bead 16 so that its exit hole 24 (FIG. 14) encompasses loops 130 and 34, a small feeler gauge (see spacer 428, FIG. 21) or other tool (e.g., tongs 118, FIG. 10) may be placed on the side of entrance hole 20 to push exit hole 24 of bead 16 back towards loops 130 and 34. FIG. 14 shows another variant of a seating station 168, which is described later in connection with description of adhesive dispensing.

During the seating operation, PE fiber 36 may be optionally gripped to ensure a feeler gauge or other spacer tool is mechanically separated from coil 28 by the gripping tool. This ensures that coil 28 is not overloaded or otherwise damaged when seating bead 16.

### Trim: Cutting Platinum Wire

FIGS. 13A and 13B show views of a clamp fixture 170 to hold sphere 16 (FIG. 13B) in place when trimming off free ends 172 of platinum wire 128. To cut wire 128 and not leave burrs, wire 128 is constrained on both sides by a clamp 176 that confronts a cut location 178 shown as a slit 180 (FIG. 13B).

Slit 180 guides a blade (not shown) during trimming. Free ends 172 of platinum wire 128 may be extended out one side of clamp 176, whereas loops 130 and 34, bead 16, PE fiber 36, and coil 28 are extended out the opposite side of clamp 176. This constrains both sides of cut location 178 so that the cutting blade may be passed through platinum wire 128, leaving behind loop 130 of platinum seated against bead 16.

Skilled persons will appreciate that other cutting techniques may be employed: laser trimming, saw trimming, or dual blade snipping (see e.g., FIG. 21).

### Dispense and Cure: Adhering Looped Component

Once sphere 16 has been seated against loops 130, 34 (i.e., essentially forming a knot inside bead 16), adhesive is applied to retain sphere 16 and loops 130, 34. For example, FIG. 14 shows seating station 168 that also acts as an adhesive dispense station. Station 168 includes a parabolic groove 186, in which bead 16 is placed. Coil 28 is axially pulled to further seat bead 16. An adhesive dispense needle 190 is moved in position to place adhesive onto trimmed end 192. Adhesive may also be applied to entrance hole 20. Also note that in some embodiments, a small amount of adhesive is applied to parabolic groove 186 prior to trim to ensure that the bead 16 does not slide away from the knot of loops 130 and 34. Similarly, in some embodiments adhesive may be applied to a tightly specified length of coil 28, e.g., to close off central aperture 38.

An example of an adhesive dispense tool is a solenoid-actuated microdot dispenser available from Xandex, Inc. of Petaluma, Calif. This type of dispenser has a reciprocating micro dispensing needle system described later in connection with FIG. 22. Jet microdispensers and pneumatic dispensers are another suitable example.

In some embodiments, a rotation fixture facilitates rotation of the workpiece about its longitudinal axis for improving distribution of adhesive. For example, a theta rotation stage is described later. And FIG. 12 shows an example of a rotation-enabled fixture in the form of collet fixture 150 that rotates within its transportable kinematic mount portion 154. Other embodiments may include rotation of the adhesive dispense needle about the workpiece.

Strands of PE fiber 36 are relatively loose and therefore rapidly absorb adhesive. To optimize wicking of adhesive through capillary action of the numerous strands and generally reduce the rate of adhesive absorption, strands are tightened by the aforementioned axial pull or by twisting PE fiber using micro tools to tighten strands and reduce capillary wicking action For example, as described later, a collet fixture has bearings allowing rotation while holding constraint, thus twisting PE fiber which minimizes wicking

In some embodiments, a pulsed UV light is used to cure adhesive applied to a workpiece. The UV light is applied after one or more microdots of adhesive are applied. A light shield (not shown) blocks UV light from reaching, and drying out the adhesive flowing from, adhesive dispense needle 190.

### Automated System

In the example of FIGS. 15 and 16, it is assumed that an automated system 194 accepts incoming partly assembled coils (shown in more detail in later figures) that have been previously configured at load, pull, bond, and exchange assembly stations 196. Partly assembled coils are then loaded 198 into a collet fixture 200 having a collet 202 and a transportable kinematic mount portion 204 to carry a coil through automated system 194. An operator 206 places one or more collet fixtures 200 onto corresponding anchored kinematic mount portions 208 integrated into a carousel 210, which is housed (or placed by operator 206) in system 194.

FIG. 15 also shows an overview of how automated system 194 uses micro tools 212 for micro assembly of a workpiece (described previously). Micro tools 212 are arranged clockwise according to an assembly sequence 218 carried out at different assembly stations 230. For example, different assembly stations 230 include a first (seat and trim) assembly station 236 (see e.g., FIG. 21) and a second (dispense and cure) assembly station 240 (see e.g., FIG. 22).

Another dispense and cure assembly station 242 is optionally included to increase throughput since two stations 240, 242 could operate simultaneously on two different workpieces. Similarly, there are spare stations that could be populated for additional redundancy. For clarity, skilled persons should appreciate that seriatim processing of a particular proximal end according to a sequence performed at several stations need to preclude parallel processing of two or more different proximal ends in different stations that would otherwise be left idle. Accordingly, some embodiments of this disclosure include those systems having additional or redundant stations.

A transport device, such as a robotic arm 250 or gantry, is configured to move a transportable kinematic mount of a collet fixture to multiple kinematic mounting sites 256 located at different assembly stations 230. As explained previously, each kinematic mounting site 256 provides a kinematic mount formed in response to attachment of a transportable kinematic mount portion to a corresponding one of multiple anchored kinematic mount portions fixed at an associated kinematic mounting site.

Multiple multi-axis motion stages 266 include a first multi-axis motion stage 270 at first assembly station 236 and a second multi-axis motion stage 272 at second assembly station 240. First multi-axis motion stage 270 is an XYZ stage and includes a first micro tool 280 that is operable to perform a micro bead or wire manipulation procedure (e.g., trim) of assembly sequence 218. Likewise, second multi-axis motion stage 272 is an XYZ and Θ (rotation) stage and includes a second micro tool 282 (e.g., a Xandex dispenser) operable to perform an adhesive micro-dispense procedure of assembly sequence 218. Thus, first and second micro tools 280, 282 are configured to act at different times on a filament of a workpiece (shown in other figures) in accordance with at least a portion of assembly sequence 218 when transportable kinematic mount portion is moved to corresponding anchored kinematic mount portions seriatim at, respectively, first and second assembly stations 236, 240.

Following an adhesive dispense and cure process (at either available dispense and cure station shown in FIG. 15), robotic arm 250 moves collet fixture 200 to an inspection station 300, which includes a camera 306 and locally or remotely executed machine vision inspection software programmed to accept or reject an assembled workpiece. This completes sequence 218, according to the present example embodiment.

Once sequence 218 is complete for all collet fixtures 200 that are kinematical remounted back on carousel 210, operator 206 removes fixtures 200 (or takes the entire populated carousel 210) from system 194 for further downstream processes 314, such as cleaning and packaging.

FIG. 16 shows a cabinet 320 for housing system 194. Cabinet 320 is sized to accommodate eventual integration of load and pull station as well as bond and exchange stations. Cabinet 320 includes an optically monitored (i.e., light curtain) opening 322 that triggers an automatic lockout for disabling system 194 when it is being accessed by user 206 (FIG. 15). Thus, carousel 210 is prevented from indexing as it is being loaded.

A computer workstation 324 is coupled to one or more inspection cameras 306 at interior assembly stations 230. Computer workstation 324 includes a machine readable storage medium having instructions stored thereon that, when executed by a processor, configure the processor to perform inspection tasks or control any of the automation tools employed in the aforementioned processes.

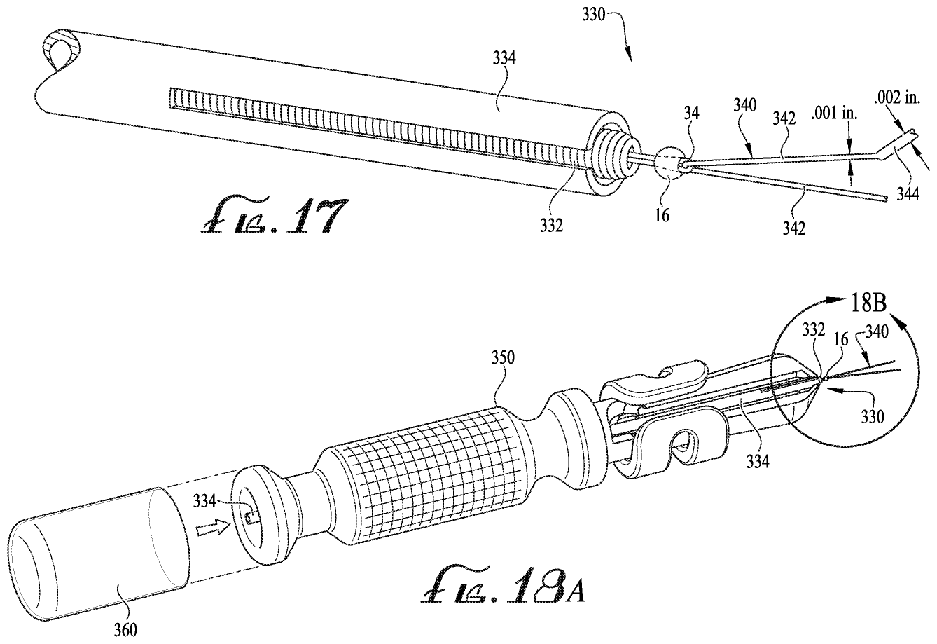

FIG. 17 is an enlarged fragmentary isometric view of a proximal end 330 of a partly assembled embolic coil 332 held in a protective sheath that is a slit tubing 334 in the present example. Slit tubing 334 allows for a gentle yet firm grip of coil 332 while also protecting coil 332 from glue buildup. As described previously, coil includes bead 16, load and pull steps have been performed elsewhere, and there is no stainless steel wire 30 to bond and exchange with a platinum wire. Instead, platinum wire 340 is preinstalled and includes die-pulled narrower segments 342 and a wider segment 344 described previously.

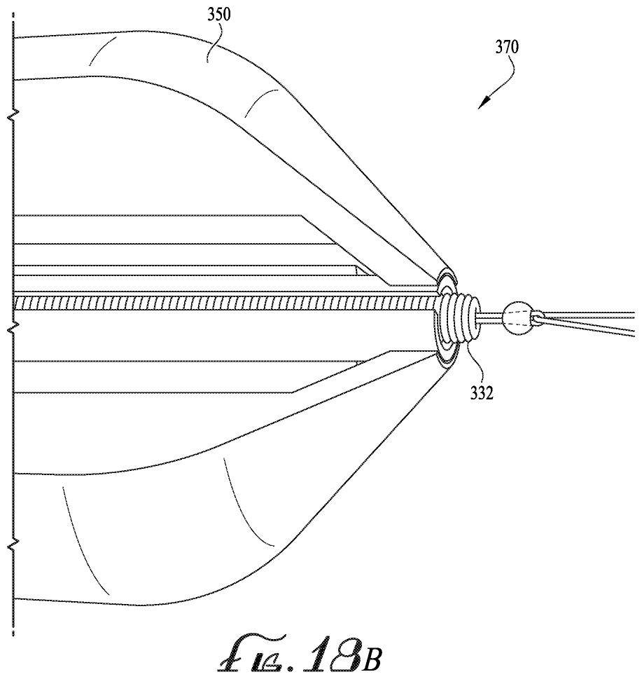

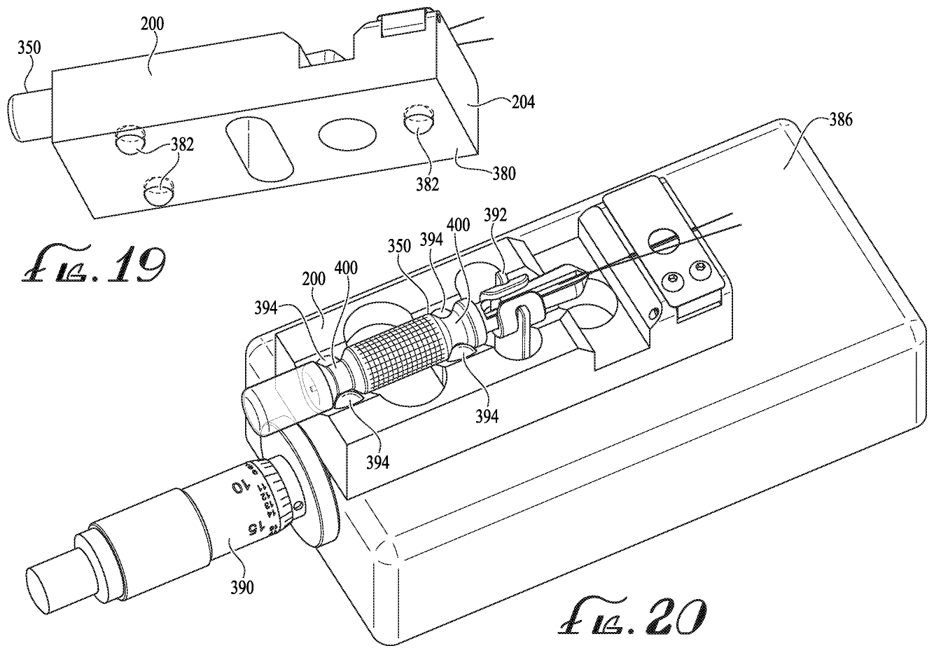

FIG. 18A is an isometric view of an extendable collet 350 holding partly assembled embolic coil 332 in slit tubing 334. Collet 350 includes an endcap 360 that may be attached after slit tubing 334 is loaded into collet 350. Endcap 360 is available in various sizes to accommodate different lengths of coils. FIG. 18B shows a tip 370 of collet 350, and extending beyond tip 370 is one end of the partly assembled coil 332, which is also generally referred to as a proximal end of coil 332.

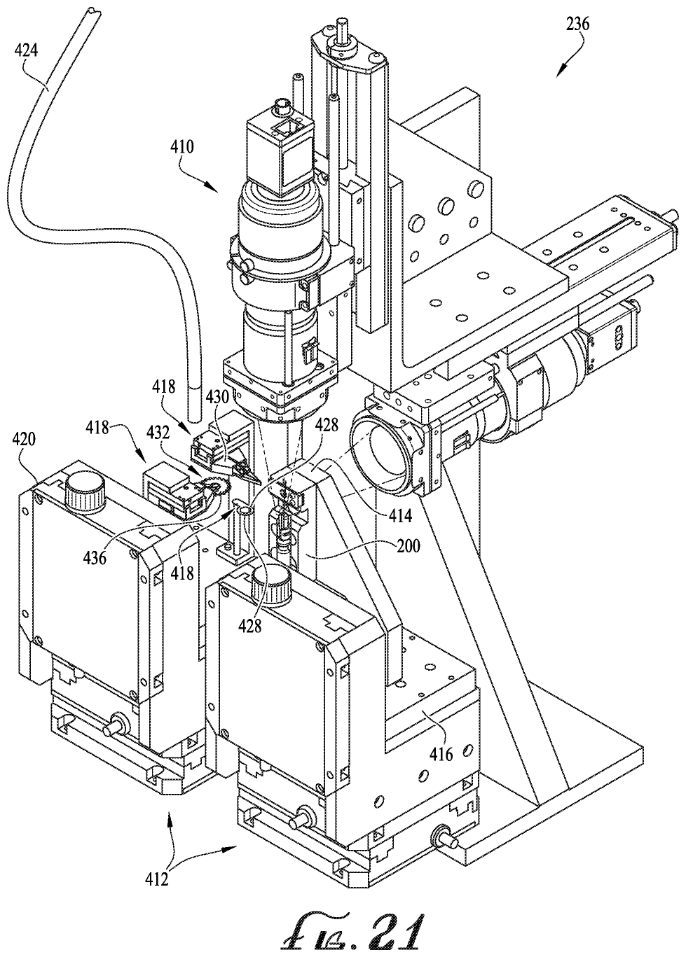

FIGS. 19 and 20 show how collet 350 is stowed in collet fixture 200 acting as a transportable kinematic mount portion 204 for carrying collet 350 to anchored kinematic mount portions. For example, FIG. 19 shows an underside 380 of portion 302 includes magnets 382 for kinematically mounting fixture 200, as described previously.

FIG. 20 also shows collet fixture 200 atop a collet positioning tool 386. Tool 386 has a micrometer adjustment dial 390 for longitudinally adjusting the location of forks 392 retaining collet 350 preparatory to loading collet fixture 200 on carousel 210. The adjustment moves collet 350 along its longitudinal axis. Rotational adjustment is made by spinning collet 350 via bearings 394 that ride in an annular bearing surface 400.

FIG. 21 is an isometric view showing in greater detail seat and trim assembly station 236. Station 236 includes a pair of orthogonally arranged cameras 410. Images are taken of the proximal end for fine alignment and incoming and outgoing inspection.

Station 236 also includes a pair of XYZ stages 412, an anchored kinematic mount portion 414 bracketed to a first stage 416 of pair 412, and seat and trim micro tools 418 mounted to a second stage 420 of pair 412. An optional vacuum line 424 and illumination source (not shown) are also included.

Seat and trim micro tools 418 are similar to those described previously. For example, a spacer 428 is used to create space between bead 16 and a proximal end of coil 332 (see e.g., space shown in FIG. 18B). A micro gripper 430 then seats bead 16 or restrains PE fiber 36 while spacer 428 is automatically moved atop its stage 420 (or stages 412 are moved relative to each other) to seat bead 16. An indexing circular trimmer tool 432 includes an upper saw 436 and a lower saw (not shown, but generally a mirror of upper saw 436) stacked directly under upper saw 436. Both saws have mutually angularly spaced-apart blades that form pairs of snippers akin to multiple scissors. Each scissor may be used to trim a wire, then rotated out of position so that the next scissor can trim the next wire, and so forth as trimmer tool is rotatably indexed. Optional integrated micro grippers above and below saws (not shown) restrain wires and perform a two-sided constraint function similar to that performed by clamp fixture 170 (FIGS. 13A and 13B).

FIG. 22 is an isometric view showing in greater detail adhesive dispense and cure assembly station 240. A solenoid-actuated adhesive dispenser 450 (e.g., a Xandex dispenser) precisely regulates and delivers a controlled amount of uncured adhesive that is applied during each actuation, thus reducing wicking down the PE fiber.

A theta stage 456 rotates the proximal end about a longitudinal axis so that a dispense tip 458 can apply adhesive droplets circumferentially around the proximal end. One or more droplets are applied and then cured in rapid succession by flickering light applied from UV device 460.

Station 240 also includes a pair of orthogonally arranged cameras 470. Images are taken of the proximal end for fine alignment and incoming and outgoing inspection.

### ADDITIONAL EXAMPLES

### Example 1

A system using micro tools for micro assembly of a workpiece that includes a component having one or both of a micro bead and a wire, the micro tools arranged according to an assembly sequence carried out at different assembly stations that include a first assembly station and a second assembly station that is different from the first assembly station, the system comprising: multiple kinematic mounting sites located at the different assembly stations, each kinematic mounting site providing a kinematic mount formed in response to attachment of a transportable kinematic mount portion to a corresponding one of multiple anchored kinematic mount portions fixed at an associated kinematic mounting site, the transportable kinematic mount portion including a depression and being sized to carry the workpiece with its component secured in the depression for presentation of the component at the different assembly stations when the transportable kinematic mount portion is transferred to and mounted at a corresponding anchored kinematic mount; multiple multi-axis motion stages including a first multi-axis motion stage at the first assembly station and a second multi-axis motion stage at the second assembly station, the first multi-axis motion stage including a first micro tool that is operable to perform a micro bead or wire manipulation procedure of the assembly sequence, and the second multi-axis motion stage including a second micro tool that is different from the first micro tool and is operable to perform an adhesive micro-dispense procedure of the assembly sequence; and the first and second micro tools are configured to act at different times on the component of the workpiece in accordance with at least a portion of the assembly sequence when the transportable kinematic mount portion is moved to corresponding anchored kinematic mount portions seriatim at, respectively, the first and second assembly stations.

### Example 2

The system of example 1, in which the transportable kinematic mount portion comprises a collet fixture.

### Example 3

The system of example 1, further comprising a robotic arm configured to move the transportable kinematic mount portion to the multiple kinematic mounting sites.

### Example 4

The system of example 1, in which the depression comprises a v-groove.

### Example 5

The system of example 1, in which the first multi-axis motion stage comprises an XYZ stage.

### Example 6

The system of example 1, in which the second multi-axis motion stage comprises an XYZ and Θ stage.

### Example 7

The system of example 1, in which the different assembly stations include a carousel having anchored kinematic mount portions affixed to or integral in a sidewall.

### Example 8

The system of example 1, in which the component includes a proximal constraint for an embolic coil.

### Example 9

The system of example 1, in which the workpiece comprises an embolic coil.

### Example 10

The system of example 9, in which the embolic coil is retained in a sheath.

### Example 11

The system of example 1, further comprising inspection cameras at the different assembly stations.

### Example 12

The system of example 1, in which the second micro tool is a solenoid-actuated microdot dispenser.

### Example 13

The system of example 1, in which the first micro tool includes microgrippers.

### Example 14

The system of example 13, in which the microgrippers are configured to perform the micro bead or wire manipulation procedure by gripping a polyethylene (PE) fiber of the workpiece.

### Example 15

The system of example 1, further comprising a third micro tool that is the same as the second micro tool and included in a redundant assembly station for improving throughput.

### Example 16

The system of example 1, in which the first micro tool includes a wire cutting tool.

### Example 17

A method of using micro tools for micro assembly of a workpiece that includes a component having one or both of a micro bead and a wire, the micro tools arranged according to an assembly sequence carried out at different assembly stations that include a first assembly station and a second assembly station that is different from the first assembly station, the method comprising: sequentially attaching a transportable kinematic mount portion to corresponding different ones of multiple anchored kinematic mount portions fixed at associated kinematic mounting sites, the transportable kinematic mount portion including a depression and being sized to carry the workpiece with its component secured in the depression for presentation of the component at the different assembly stations when the transportable kinematic mount portion is transferred to and mounted at an anchored kinematic mount; controlling multiple multi-axis motion stages including a first multi-axis motion stage at the first assembly station and a second multi-axis motion stage at the second assembly station, the first multi-axis motion stage including a first micro tool that is operable to perform a micro bead or wire manipulation procedure of the assembly sequence, and the second multi-axis motion stage including a second micro tool that is different from the first micro tool and is operable to perform an adhesive micro-dispense procedure of the assembly sequence; and processing the component of the workpiece with the first and second micro tools in accordance with at least a portion of the assembly sequence when the transportable kinematic mount portion is moved to corresponding anchored kinematic mount portions seriatim at, respectively, the first and second assembly stations.

### Example 18

The method of example 17, further comprising seating a bead using the first micro tool.

### Example 19

The method of example 17, further comprising trimming a wire using the first micro tool.

### Example 20

The method of example 17, further comprising applying adhesive to a wire using the second micro tool.

### Example 21

The method of example 17 performed by the system of any one of examples 1-16.

### CONCLUDING REMARKS

Skilled persons will appreciate that many changes may be made to the details of the above-described embodiments without departing from the underlying principles of the invention. For instance, collet 202 itself could be kinematically mounted, in which case it could serve as a transportable kinematic mount portion. The scope of the present invention should, therefore, be determined only by the following claims.

1. A system using micro tools for micro assembly of a workpiece that includes a component having one or both of a micro bead and a wire, the micro tools arranged according to an assembly sequence carried out at different assembly stations that include a first assembly station and a second assembly station that is different from the first assembly station, the system comprising:
multiple kinematic mounting sites located at the different assembly stations, each kinematic mounting site providing a kinematic mount formed in response to attachment of a transportable kinematic mount portion to a corresponding one of multiple anchored kinematic mount portions fixed at an associated kinematic mounting site, the transportable kinematic mount portion including a depression and being sized to carry the workpiece with its component secured in the depression for presentation of the component at the different assembly stations when the transportable kinematic mount portion is transferred to and mounted at a corresponding anchored kinematic mount;
multiple multi-axis motion stages including a first multi-axis motion stage at the first assembly station and a second multi-axis motion stage at the second assembly station, the first multi-axis motion stage including a first micro tool that is operable to perform a micro bead or wire manipulation procedure of the assembly sequence, and the second multi-axis motion stage including a second micro tool that is different from the first micro tool and is operable to perform an adhesive micro-dispense procedure of the assembly sequence; and
the first and second micro tools are configured to act at different times on the component of the workpiece in accordance with at least a portion of the assembly sequence when the transportable kinematic mount portion is moved to corresponding anchored kinematic mount portions seriatim at, respectively, the first and second assembly stations.

2. The system of claim 1, in which the transportable kinematic mount portion comprises a collet fixture.

3. The system of claim 1, further comprising a robotic arm configured to move the transportable kinematic mount portion to the multiple kinematic mounting sites.

4. The system of claim 1, in which the depression comprises a v-groove.

5. The system of claim 1, in which the first multi-axis motion stage comprises an XYZ stage.

6. The system of claim 1, in which the second multi-axis motion stage comprises an XYZ and Θ stage.

7. The system of claim 1, in which the different assembly stations include a carousel having anchored kinematic mount portions affixed to or integral in a sidewall.

8. The system of claim 1, in which the component includes a proximal constraint for an embolic coil.

9. The system of claim 1, in which the workpiece comprises an embolic coil.

10. The system of claim 9, in which the embolic coil is retained in a sheath.

11. The system of claim 1, further comprising inspection cameras at the different assembly stations.

12. The system of claim 1, in which the second micro tool is a solenoid-actuated microdot dispenser.

13. The system of claim 1, in which the first micro tool includes microgrippers.

14. The system of claim 13, in which the microgrippers are configured to perform the micro bead or wire manipulation procedure by gripping a polyethylene (PE) fiber of the workpiece.

15. The system of claim 1, further comprising a third micro tool that is the same as the second micro tool and included in a redundant assembly station for improving throughput.

16. The system of claim 1, in which the first micro tool includes a wire cutting tool.

17. A method of using micro tools for micro assembly of a workpiece that includes a component having one or both of a micro bead and a wire, the micro tools arranged according to an assembly sequence carried out at different assembly stations that include a first assembly station and a second assembly station that is different from the first assembly station, the method comprising:
sequentially attaching a transportable kinematic mount portion to corresponding different ones of multiple anchored kinematic mount portions fixed at associated kinematic mounting sites, the transportable kinematic mount portion including a depression and being sized to carry the workpiece with its component secured in the depression for presentation of the component at the different assembly stations when the transportable kinematic mount portion is transferred to and mounted at an anchored kinematic mount;
controlling multiple multi-axis motion stages including a first multi-axis motion stage at the first assembly station and a second multi-axis motion stage at the second assembly station, the first multi-axis motion stage including a first micro tool that is operable to perform a micro bead or wire manipulation procedure of the assembly sequence, and the second multi-axis motion stage including a second micro tool that is different from the first micro tool and is operable to perform an adhesive micro-dispense procedure of the assembly sequence; and
processing the component of the workpiece with the first and second micro tools in accordance with at least a portion of the assembly sequence when the transportable kinematic mount portion is moved to corresponding anchored kinematic mount portions seriatim at, respectively, the first and second assembly stations.

18. The method of claim 17, further comprising seating a bead using the first micro tool.

19. The method of claim 17, further comprising trimming a wire using the first micro tool.

20. The method of claim 17, further comprising applying adhesive to a wire using the second micro tool.
